(19) United States
(12) Patent Application Publication
(10) Pub. No.: US 2024/0039725 A1
(43) Pub. Date: Feb. 1, 2024

(54) SYSTEM AND METHOD FOR EDITING CUSTOM DECORATED DIGITAL IMAGE AND ISSUING THEM AS NON FUNGIBLE TOKEN

(71) Applicant: Kaura Inc., Seocho-gu (KR)

(72) Inventor: Jae Ho KANG, Seoul (KR)

(73) Assignee: Kaura Inc., Seocho-gu (KR)

(21) Appl. No.: 18/360,403

(22) Filed: Jul. 27, 2023

(30) Foreign Application Priority Data
Jul. 27, 2022 (KR) 10-2022-0093330

(51) Int. Cl. H04L 9/32; G06T 3/40; G06V 10/56; G06T 11/60

(52) U.S. Cl. CPC H04L 9/3213; G06T 3/40; G06V 10/56; G06T 11/60

(57) ABSTRACT

The present invention relates to a system and a method for editing a custom decorated digital image and issuing them as a non fungible token, and according to an exemplary embodiment of the present invention, the NFT issuance system for issuing custom decorated digital images as a non fungible token (NFT) may include: a user terminal device; a service providing server; and a blockchain server, and the user terminal device may recognize and authenticate a digital image related identifier, the service providing server may provide a digital image and a decoration code for decoration edition to the user terminal device based on the authenticated identifier, the user terminal device may enter a decoration page related to the provided digital image, and perform the decoration edition on a digital image provided based on the provided decoration code in the decoration page to generate and store the custom decorated digital image, the service providing server may receive an NFT issuance request for the generated and stored custom decorated digital image from the user terminal device and transfer the received NFT issuance request to the blockchain server, and the blockchain server may issue an NFT for the generated and stored custom decorated digital image to the service providing server.

### CROSS-REFERENCE TO RELATED APPLICATIONS

This application claims the priority of Korean Patent Application No. 10-2022-0093330 filed on Jul. 27, 2022, in the Korean Intellectual Property Office, the disclosure of which is incorporated herein by reference.

### BACKGROUND OF THE INVENTION

### Field of the Invention

The present invention relates to a system and a method for editing a custom decorated digital image and issuing them as a non fungible token which issue an edited custom decorated digital image as a non fungible token (NFT), and more particularly, to a technology in which a user terminal device is paid with a digital image through a service providing server, add decoration to the paid digital image to generate and store the custom decorated digital image, and issue the custom decorated digital image as the NFT through a blockchain server.

### Description of the Related Art

In recent years, the demand for editing a custom decorated digital image and using the edited digital image as a profile picture of a social networking service (SNS) account has increased.

Further, as the sensitivity of an ownership for the digital image increases, a market demand for issuance of a non fungible token (NFT) which is referred to as a non-fungible token as an ownership authentication means of the digital image has been expanded.

As a blockchain based cryptocurrency, the NFT can be distinguished from a fungible token (FT) which is referred to as a fungible token.

The NFT is a token each having a unique value, and it is impossible that respective tokens are compatible with each other.

A blockchain based non-fungible token can be primarily used as a digital right certificate representing an ownership or qualification of an asset having a unique number, such as tickets, real estate, income right, coupons, and digital collectors.

The NFT can emphasize scarcity by limiting the total issuance amount through a blockchain based smart contact, and may have irreversibility because it is impossible to modify the NFT after issuance.

However, in the conventional technology, a process of issue the NFT by additionally interlocking with a platform capable of issuing the NFT is required in order to edit the custom decorated digital image by using a photo edition application, storing the digital image in user terminals such as a telephone and a computer, and issue the stored image as the NFT.

In other words, in the conventional technology, the process of editing the custom decorated digital image as and storing the digital image, and the process of issuing the digital image as the NFT are made in separated systems, so there is a problem that reduces convenience depending on the user's hassle in the issuance process of the NFT, which is inconvenient for ordinary people who do not have a technical understanding of the NFT.

### SUMMARY OF THE INVENTION

The present invention has been made in an effort to being paid with, by a user terminal device, a digital image though a service providing server, adding decoration to the paid digital image to generate and store the custom decorated digital image, and issuing the custom decorated digital image as a non fungible token (NFT) through a blockchain server.

The present invention has also been made in an effort to provide a system and a method for editing custom decorated digital images which issue custom decorated digital images as the NFT, which perform both a process of generating and storing custom decorated digital images and a process of issuing the custom decorated digital images as the NFT through a decoration edition of adding a decoration sticker onto the digital images according to one service flow to enhance convenience of a user.

According to an exemplary embodiment of the present invention, an NFT issuance system for issuing custom decorated digital images as a non fungible token (NFT) may include: a user terminal device; a service providing server; and a blockchain server, and the user terminal device may recognize and authenticate a digital image related identifier, the service providing server may provide a digital image and a decoration code for decoration edition to the user terminal device based on the authenticated identifier, the user terminal device may enter a decoration page related to the provided digital image, and perform the decoration edition on a digital image provided based on the provided decoration code in the decoration page to generate and store the custom decorated digital image, the service providing server may receive an NFT issuance request for the generated and stored custom decorated digital image from the user terminal device and transfer the received NFT issuance request to the blockchain server, and the blockchain server may issue an NFT for the generated and stored custom decorated digital image to the service providing server.

The user terminal device may recognize and authenticate the identifier of any one of a QR code, a barcode, and an RFID tag, enters a log-in page of the service providing server, be paid with a digital image corresponding to an identifier recognized and authenticated in the entering log-in page, and perform the decoration edition on the paid digital image and combines a plurality of decoration stickers to generate and store the custom decorated digital image, and transfer an NFT issuance request for the custom decorated digital image generated and stored through the service providing server to the blockchain server to be issued with the NFT for the custom decorated digital image generated and stored through the service providing server from the blockchain server.

The user terminal device may select at least one of a plurality of decoration stickers provided by the service providing server based on the provided decoration code to perform at least one decoration edition of location designation, color filter application, color change, transparency change, and size fluctuation related to movement, enlargement, reduction, and rotation of at least one decoration sticker selected on the digital image.

The decoration code may be configured to call a coordinate and an attribute value of at least one selected decoration sticker on the digital image, modify the called coordinate and attribute value according to the decoration edition, and recall the modified coordinate and attribute value to generate the custom decorated digital image.

The service providing server may upload the generated and stored custom decorated digital image to a distribution storage, and receive individual addresses from the distribution storage to generate metadata according to a request for generating the metadata, and transfer the NFT issuance request for the generated and stored custom decorated digital image with the generated metadata to the blockchain server.

The user terminal device may display the issued NFTs according to an issuance order, display the thumbnail and names of the issued NFTs, move a detailed screen of an NFT of which name is displayed when detecting an input for the thumbnail, and display the custom decorated digital images, names, NFT owner nicknames, and NFT issuance dates on the detailed screen.

The service providing server may provide the digital images and the decoration codes for the decoration edition to the user terminal device based on the authenticated identifier, and then distinctively control a clarity for the provided digital image according to whether log-in is made in a log-in page of the service providing server in the user terminal device.

According to an exemplary embodiment of the present invention, an NFT issuance method for issuing custom decorated digital images as a non fungible token (NFT) may include: recognizing and authenticating, by a user terminal device, a digital image related identifier; providing, by a service providing server, a digital image and a decoration code for decoration edition to the user terminal device based on the authenticated identifier; entering, by the user terminal device, a decoration page related to the provided digital image, and performing the decoration edition on a digital image provided based on the provided decoration code in the decoration page to generate and store the custom decorated digital image; receiving, by the service providing server, an NFT issuance request for the generated and stored custom decorated digital image from the user terminal device and transfers the received NFT issuance request to the blockchain server; and issuing, by the blockchain server, an NFT for the generated and stored custom decorated digital image to the service providing server.

According to an exemplary embodiment of the present invention, the NFT issuance method may further include: recognizing and authenticating, by the user terminal device, the identifier of any one of a QR code, a barcode, and an RFID tag, entering a log-in page of the service providing server, being paid with a digital image corresponding to an identifier recognized and authenticated in the entering log-in page; and performing, by the user terminal device, the decoration edition on the paid digital image and combining a plurality of decoration stickers to generate and store the custom decorated digital image, and transferring an NFT issuance request for the custom decorated digital image generated and stored through the service providing server to the blockchain server to be issued with the NFT for the custom decorated digital image generated and stored through the service providing server from the blockchain server.

The entering of, by the user terminal device, the decoration page related to the provided digital image, and performing the decoration edition on the digital image provided based on the provided decoration code in the decoration page to generate and store the custom decorated digital image may include selecting at least one of a plurality of decoration stickers provided by the service providing server based on the provided decoration code to perform at least one decoration edition of location designation, color filter application, color change, transparency change, and size fluctuation related to movement, enlargement, reduction, and rotation of at least one decoration sticker selected on the digital image, and the decoration code may be configured to call a coordinate and an attribute value of at least one selected decoration sticker on the digital image, modify the called coordinate and attribute value according to the decoration edition, and recall the modified coordinate and attribute value to generate the custom decorated digital image.

The receiving of the NFT issuance request for the generated and stored custom decorated digital image from the user terminal device and transferring the received NFT issuance request to the blockchain server may include uploading the generated and stored custom decorated digital image to a distribution storage, and receiving individual addresses from the distribution storage to generate metadata according to a request for generating the metadata, and transferring the NFT issuance request for the generated and stored custom decorated digital image with the generated metadata to the blockchain server.

The providing of the digital image and the decoration code for decoration edition to the user terminal device based on the authenticated identifier may include providing the digital images and the decoration codes for the decoration edition to the user terminal device based on the authenticated identifier, and then controlling a clarity for the provided digital image according to whether log-in is made in a log-in page of the service providing server in the user terminal device.

According to an exemplary embodiment of the present invention, a service providing server of an NFT issuance system for issuing custom decorated digital images as a non fungible token (NFT) may include: an identifier registration unit providing, after recognizing and authenticating a digital image related identifier by a user terminal device, a digital image to the user terminal device based on the authenticated identifier; a decoration performing unit providing a decoration code for decoration edition in relation to the provided digital image, and performing the decoration edition on the provided digital image based on the provided decoration code in the decoration page to generate and store the custom decorated digital image; an NFT issuance unit receiving an NFT issuance request for the generated and stored custom decorated digital image from the user terminal device and transferring the received NFT issuance request to a blockchain server; and an NFT withdrawal unit requesting NFT withdrawal so as for the blockchain server to issue an NFT for the generated and stored custom decorated digital image.

The decoration performing unit may support the user terminal device to select at least one of a plurality of decoration stickers provided by the service providing server based on the provided decoration code to perform at least one decoration edition of location designation, color filter application, color change, transparency change, and size fluctuation related to movement, enlargement, reduction, and rotation of at least one decoration sticker selected on the digital image.

The decoration code may be configured to call a coordinate and an attribute value of at least one selected decoration sticker on the digital image, modify the called coordinate and attribute value according to the decoration edition, and recall the modified coordinate and attribute value to generate the custom decorated digital image.

According to the present invention, a user terminal device can be paid with a digital image though a service providing server, add decoration to the paid digital image to generate and store the custom decorated digital image, and issue the custom decorated digital image as a non fungible token (NFT) through a blockchain server.

The present invention can provide a system and a method for editing custom decorated digital images which issue custom decorated digital images as the NFT, which perform both a process of generating and storing custom decorated digital images and a process of issuing the custom decorated digital images as the NFT through a decoration edition of adding a decoration sticker onto the digital images according to one service flow to enhance convenience of a user.

### BRIEF DESCRIPTION OF THE DRAWINGS

FIGS. 1 and 2 are diagrams for describing a system for editing custom decorated digital images as an NFT which issue custom decorated digital images as the NFT according to an exemplary embodiment of the present invention.

FIGS. 3A to 3E are diagrams for describing a service procedure of issuing custom decorated digital images as an NFT according to an exemplary embodiment of the present invention.

FIG. 4 is a diagram for describing a screen of managing custom decorated digital images and an issued NFT according to an exemplary embodiment of the present invention.

FIGS. 5A to 5E are diagrams for describing a decoration code for generating custom decorated digital images according to an exemplary embodiment of the present invention.

FIGS. 6 and 7 are diagrams for describing a method for editing custom decorated digital images as an NFT which issue custom decorated digital images as the NFT according to an exemplary embodiment of the present invention.

### DETAILED DESCRIPTION OF THE PREFERRED EMBODIMENT

Hereinafter, various exemplary embodiments of the present invention will be described with reference to the accompanying drawings.

The exemplary embodiments and terms used therefor do not intend to limit techniques disclosed in the present invention to specific exemplary embodiments, and it should be understood that the exemplary embodiments and the terms include various modifications, equivalents, and/or substitutes of the corresponding exemplary embodiment.

Hereinbelow, in describing various exemplary embodiments, detailed description of associated known function or constitutions will be omitted if it is determined that they unnecessarily make the gist of the present invention unclear.

In addition, terms to be described below, as terms which are defined in consideration of functions in various embodiments, may vary depending on the intention of a user or an operator or usual practices. Accordingly, the terms need to be defined based on contents throughout this specification.

In connection with the description of the drawings, similar reference numerals may be used for similar components.

A singular form may include a plural form unless otherwise clearly meant in the contexts.

In the present invention, expressions such as “A or B” or “at least one of A and/or B” may include all possible combinations of items listed together.

Expressions such as “first,” and “second,” can modify the corresponding components regardless of their order or importance, and will be used only to distinguish one component from another component, but are not limit the components.

When any (e.g., first) component is referred to as being “(functionally or communicatively) connected” or “accessed” to the other (e.g., second) component, the component may be directly connected to the other component, or may be connected through another component (e.g., a third component).

In this specification, “configured to” may be used interchangeably with, for example, “suitable for,” “having the ability to,” “changed to”, “made to”, “capable of”, or “designed to” in hardware or software, depending on the situation.

In some situations, the expression “a device configured to” may mean that the device “capable of” together with other devices or parts.

For example, the phrase “a processor configured to perform A, B, and C” may mean a dedicated processor (e.g., an embedded processor) for performing the operation, or a general-purpose processor (e.g., a CPU or application processor) capable of performing the corresponding operations by executing one or more software programs stored in a memory device.

Also, the term ‘or’ means an inclusive logical sum ‘inclusive or’ rather than an exclusive logical sum ‘exclusive or’.

That is, unless stated otherwise or unless clear from the context, the expression of ‘x uses a or b’ means any one of natural inclusive permutations.

Terms such as ‘part’ and ‘unit’ used herein mean a unit that processes at least one function or operation, which may be implemented by hardware or software or a combination of hardware and software.

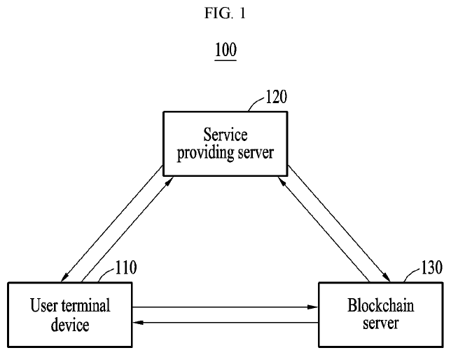

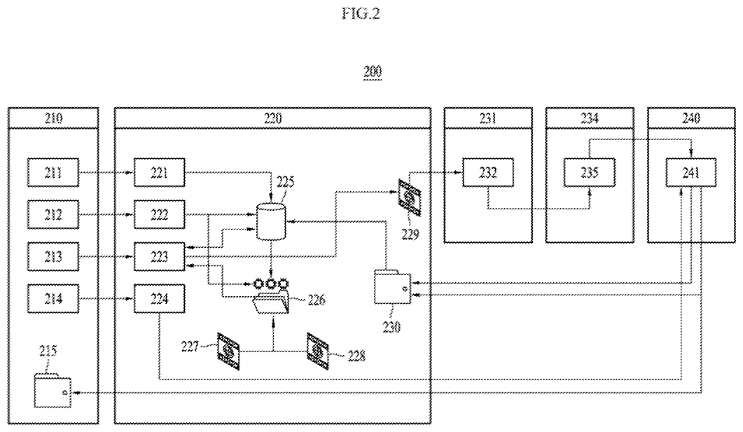

FIGS. 1 and 2 are diagrams for describing a system for editing custom decorated digital images as an NFT which issue custom decorated digital images as the NFT according to an exemplary embodiment of the present invention.

FIG. 1 illustrates a component of a system for editing custom decorated digital images as an NFT which issue custom decorated digital images as the NFT according to an exemplary embodiment of the present invention. Hereinafter, for convenience of description, the system for editing custom decorated digital images as an NFT which issue custom decorated digital images as the NFT will be referred to as an NFT issuance system.

Referring to FIG. 1, an NFT issuance system 100 according to an exemplary embodiment of the present invention is constituted by a user terminal device 110, a service providing server 120, and a blockchain server 130.

As an example, the NFT issuance system 100 may be an NFT issuance system that issues custom decorated digital images as a non fungible token (NFT).

According to an exemplary embodiment of the present invention, the user terminal device 110 recognizes and authenticates a digital image related identifier.

As an example, the user terminal device 110 may recognize and authenticate the identifier of any one of a QR code, a barcode, and an RFID tag.

According to an exemplary embodiment of the present invention, the service providing server 120 provides digital images and decoration codes for decoration edition to the user terminal device 110 based on the authenticated identifier.

For example, the digital images as digital original images before decoration addition may be portrait photos, animal photos, objects, character images, and paintings drawn by painters.

The user terminal device 110 enters a decoration page related to a digital image to be decorated, and performs the decoration edition on a digital image provided based on the decoration code provided in the decoration page to generate and store the custom decorated digital image.

That is, the user terminal device 110 enters a log-in page of the service providing server 120, is paid with a digital image corresponding to an identifier recognized and authenticated in the entering log-in page, and performs the decoration edition on the paid digital image and combines a plurality of decoration stickers to generate and store the custom decorated digital image.

As an example, the user terminal device 110 transfers an NFT issuance request for the custom decorated digital image generated and stored through the service providing server 120 to the blockchain server 130 to be issued with the NFT for the custom decorated digital image generated and stored through the service providing server 120 from the blockchain server 130.

In this case, the service providing server 120 receives and stores the custom decorated digital image from the user terminal device 110, and receives the NFT issuance request for the stored custom decorated digital image to conduct the NFT issuance request to the blockchain server 130.

That is, the service providing server 120 requests NFT generation and issuance for the custom decorated digital image to the blockchain server 130.

The user terminal device 110 selects at least one of a plurality of decoration stickers provided by the service providing server based on the decoration code provided from the service providing server 120 to perform at least one decoration edition of location designation, color filter application, color change, transparency change, and size fluctuation related to movement, enlargement, reduction, and rotation of at least one decoration sticker selected on the digital image.

For example, the decoration code may be configured to call a coordinate and an attribute value of at least one decoration sticker on the digital image, modify the called coordinate and attribute value according to the decoration edition, and recall the modified coordinate and attribute value to generate the custom decorated digital image.

The service providing server 120 uploads the generated and stored custom decorated digital image to a distribution storage, and receives individual addresses from the distribution storage to generate metadata according to a request for generating the metadata.

Further, the service providing server 120 may transfer the NFT issuance request for the custom decorated digital image generated and stored as the generated metadata to the blockchain server 130.

That is, the service providing server 120 may enhance the security for an NFT to be generated by using the distribution storage.

As an example, the service providing server 120 may provide the digital images and the decoration codes for the decoration edition to the user terminal device based on the authenticated identifier, and then distinctively control a clarity for the digital image in displaying the digital image according to whether log-in is made in a log-in page of the service providing server 120 in the user terminal device 110.

For example, the service providing server 120 may determine the user as a member based on log-in information when log-in is made, and provide the digital image blurrily or clearly.

According to an exemplary embodiment of the present invention, the blockchain server 130 may issue the NFT according to the NFT issuance request for the customer decorated digital image, and transfer the issued NFT to the user terminal device 110 through the service providing server 120.

Therefore, according to the present invention, the user terminal device can be paid with the digital image though the service providing server, add decoration to the paid digital image to generate and store the custom decorated digital image, and issue the custom decorated digital image as the non fungible token (NFT) through the blockchain server.

According to an exemplary embodiment of the present invention, the user terminal device 110 may perform image data storage, an NFT issuance request, and an NFT withdrawal request to the service providing server 120.

As an example, the service providing server 120 may make the NFT issuance request and request an NFT owner change for the custom decorated digital image in the user terminal device 110 to the blockchain server 130.

According to an exemplary embodiment of the present invention, the user terminal device 110 may transfer possessed NFT query and NFT market listing requests to the blockchain server 130.

The NFT issuance system 100 according to an exemplary embodiment of the present invention may additionally include an NFT market web server (not illustrated).

As an example, the user terminal device 110 may apply for the listed NFT inquiry and apply for listable NFT inquiry to the NFT market web server.

Further, the service providing server 120 may apply for the NFT inquiry issued through the blockchain server 130 and the listed NFT inquiry.

FIG. 2 more specifically illustrates a component of a system for editing custom decorated digital images as an NFT which issue custom decorated digital images as the NFT according to an exemplary embodiment of the present invention. Hereinafter, for convenience of description, the system for editing custom decorated digital images as an NFT which issue custom decorated digital images as the NFT will be referred to as an NFT issuance system.

Referring to FIG. 2, an NFT issuance system 200 according to an exemplary embodiment of the present invention may be constituted by a user terminal device 210, a service providing server 220, and a blockchain server 240, and the service providing server 220 may additionally use a distribution storage 231 and a metadata generation server 233.

According to an exemplary embodiment of the present invention, the user terminal device 210 includes a QR code registration request unit 211, a decoration performing unit 212, an NFT issuance request unit 213, an NFT withdrawal request unit 214, and a decentralization wallet unit 215.

As an example, the service providing server 220 includes a QR code registration unit 221, a decoration performing unit 222, an NFT issuance unit 223, and an the NFT withdrawal unit 224 to correspond to the QR code registration request unit 211, the decoration performing unit 212, the NFT issuance request unit 213, and the NFT withdrawal request unit 214, respectively.

According to an exemplary embodiment of the present invention, the service providing server 220 is a service providing server of the NFT issuance system 200 that issues the custom decorated digital image as the NFT.

For example, the service providing server 220 may support and manage a process in which the user terminal device 210 edits and generates the customer decorated digital image, and then issues the customer decorated digital image as the NFT.

The QR code registration unit 221 stores, in a QR database 225, QR data to belong to a user. That is, data related to a digital image recognized through the QR code is stored to belong to a specific user.

For example, the QR code registration unit 221 may be referred to as an identifier registration unit.

As an example, the identifier registration unit may recognize and authenticate a digital image related identifier in the user terminal device 210, and then provide the digital image to the user terminal device 210 based on the authenticated identifier.

The decoration performing unit 222 registers a decoration setting JSON file name in the QR data in a QR database 225. Here, the decoration setting JSON file may be related to the decoration code.

That is, the decoration setting JSON file may be the custom decorated digital image.

Further, the decoration performing unit 2222 uploads the decoration setting JSON file to a JSON file storage unit 226 storing decoration setting data.

As an example, the decoration performing unit 222 may provide the decoration code for decoration edition with respect to the digital image, and support the user terminal device 210 to generate and store the custom decorated digital image by performing the decoration edition on the digital image based on a pre-provided decoration code in the decoration page.

That is, the decoration performing unit 222 may support the user terminal device 210 to select at least one of a plurality of decoration stickers provided by the service providing server 220 based on the provided decoration code and perform at least one decoration edition of location designation, color filter application, color change, transparency change, and size fluctuation related to movement, enlargement, reduction, and rotation of at least one decoration sticker on the digital image.

For example, the decoration code may be configured to call a coordinate and an attribute value of at least one decoration sticker on the digital image, modify the called coordinate and attribute value according to the decoration edition, and recall the modified coordinate and attribute value to generate the custom decorated digital image.

The NFT issuance unit 223 may query the JSON file name in the QR database 225, and the NFT issuance unit 223 may load an image combination from the JSON file storage unit 226 by JSON file setting.

As an example, the NFT issuance unit 223 may receive the NFT issuance request for the custom decorated digital image from the user terminal device 210 and transfer the NFT issuance request to the blockchain server 240.

According to an exemplary embodiment of the present invention, the NFT withdrawal unit 224 may request NFT withdrawal so as for the blockchain server 240 to issue the NFT for the custom decorated digital image.

The JSON file storage unit 226 stores information on a sticker image file 227 and an original image file 228, and a file name, a coordinate, a transparency, a color, rotation, enlargement, and reduction of the sticker image file 227 are controlled by the decoration code.

The sticker image file 227 and the original image file 228 are combined to become a custom decorated digital image 229.

The NFT issuance unit 223 may receive the NFT issuance request for the custom decorated digital image by combining of the information stored in the QR database 225 and the JSON file storage unit 226 from the user terminal device 210 and transfer the NFT issuance request to the blockchain server 240.

As a result, the NFT issuance unit 223 uploads the customer decorated digital image 229 to the distribution storage 231, and the distribution storage unit 231 returns individual addresses with respect to the customer decorated digital images uploaded by the image distribution server 232.

Further, the image distribution server 232 requests metadata generation to the metadata generation unit 234 of the metadata generation server 233 according to the address return.

The metadata generation unit 232 transfers an on-chain issuance request to the blockchain server 240 with the generated metadata, and the blockchain server 240 conducts NFT issuance in an NFT issuance program unit 241 and transfers the NFT to a centralization wallet unit 230 of the service providing server 220.

The service providing server 220 transfers the NFT to the decentralization wallet unit 215 while notifying NFT issuance completion to the user terminal device 210.

The centralization wallet unit 230 performs attribution for an NFT of which generation is completed in the QR in the QR database 225.

That is, the service providing server 220 stores, in the QR database 225, an attribution result according to the NFT processing for the digital image corresponding to the QR code.

When the blockchain server 240 receives NFT owner change request from the user terminal device 210 and the service providing server 220, the blockchain server 240 may also conduct NFT owner change processing.

The NFT issuance system 200 according to an exemplary embodiment of the present invention may support the user to conduct a process of generating the customer decorated digital images, encoding image addresses for the generated digital images through the distribution server 231, generating metadata according to the encoded image addresses in the metadata generation server 233, issuing the NFT in the blockchain through the on-chain by the blockchain server 240, and then dropping the issued NFT the decentralization wallet unit 215 of the user terminal device 210 only by clicking on an NFT generation tab.

That is, the NFT issuance system 200 processes a process from image decoration to dropping to the wallet in the user terminal device 210 in a single service flow to enhance convenience of the user.

According to an exemplary embodiment of the present invention, the NFT issuance system 200 may be a system that decorates and stores the digital images in the single service flow, and issue the stored customer decorated digital images as the NFT.

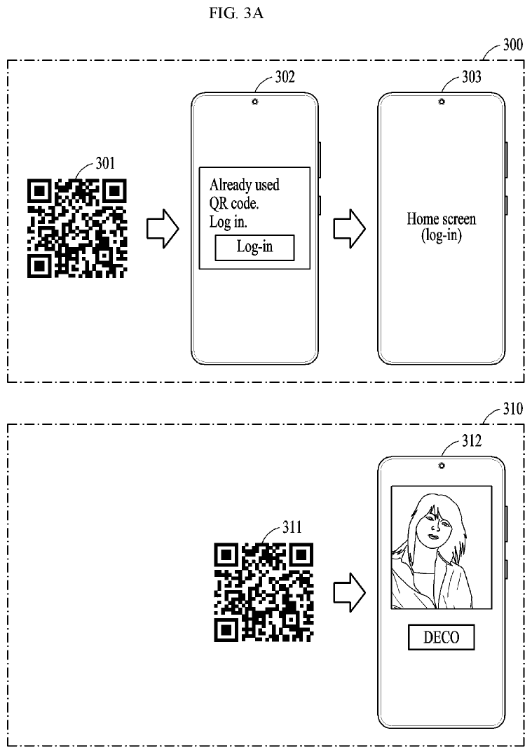

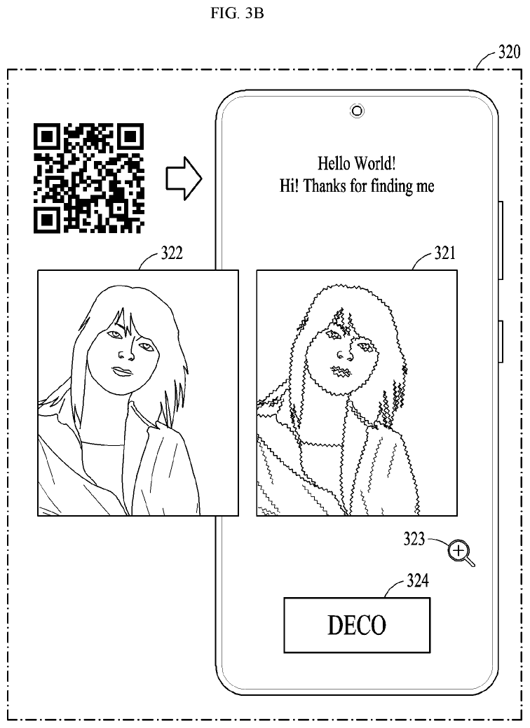

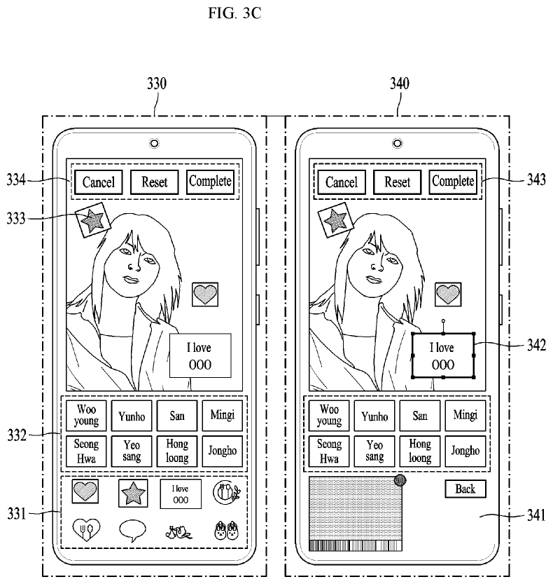

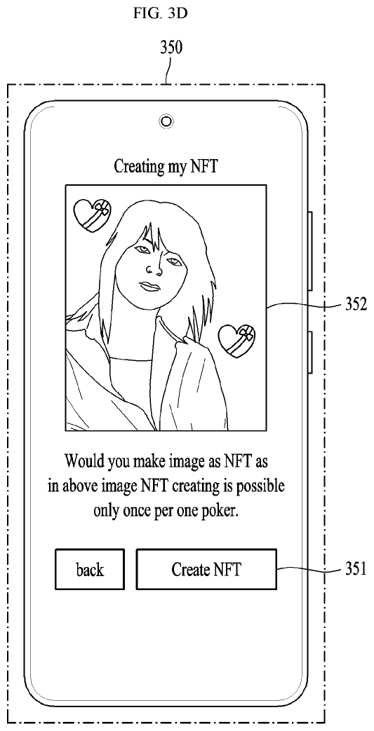

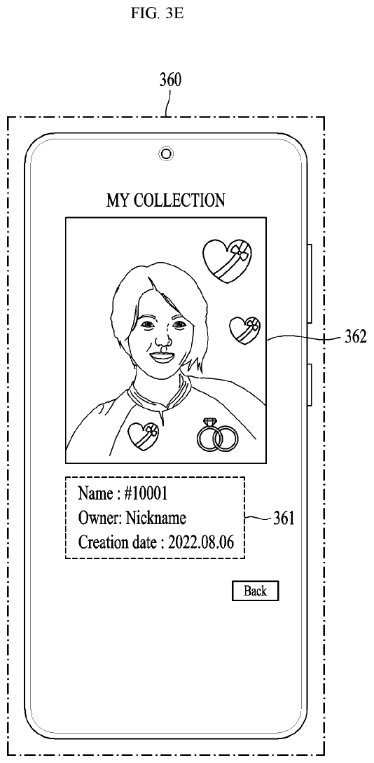

FIGS. 3A to 3E are diagrams for describing a service procedure of issuing custom decorated digital images as an NFT according to an exemplary embodiment of the present invention.

FIG. 3A illustrates a display screen according to identifier recognition and authentication in a service procedure of the issuing the custom decorated digital images as the NFT according to an exemplary embodiment of the present invention.

Referring to FIG. 3A, in the case of a pre-used identifier (300), a QR code 301 is recognized as the identifier, log-in is induced while guiding that the QR code 301 is a QR code already used in a screen 302, and a screen 303 is changed to a log-in page.

In the case of a new identifier (310), a QR code 311 is recognized as the identifier, and a digital image corresponding to the QR code 311 is provided as a cloudy image in a screen 312.

According to an exemplary embodiment of the present invention, with respect to an access path through QR code scanning by interlocking with the service providing server, the user terminal device may display only a message pop-up window in an empty screen in some cases, and check a language of an access device, and applies language setting according to the check.

A normal access check-in case is confirmed according to the QR code 310, and in the case of an existing a QR code which goes through member joining, a pop-up window is displayed like the screen 300 and the screen moves to the log-in screen.

Meanwhile, a digital photo card screen may be provided, which provides the digital image like the screen 312 according to the QR code 311.

Here, a DECO tab may be jointly displayed, which enables entering the screen that decorates the digital image in the screen 312.

FIG. 3B illustrates a digital photo card drop page in the service procedure of the issuing the custom decorated digital images as the NFT according to an exemplary embodiment of the present invention.

Referring to FIG. 3B, a digital photo card drop page 320 which is provided as a page which provides the digital image based on the QR code recognition and authentication provides a clear digital image 322 in case of a log-in state and provides a blurring digital image 321 in case of a non-log-in state.

The user terminal device guides member joining when detecting an input for an enlargement item 323 in the non-log-in state.

The user terminal device provides a high-definition image when detecting the input for the enlargement item 323 in the log-in state.

The user terminal device provides a guidance message representing the log-in is required in the non-log-in state.

The user terminal device provides a storage function for a high-definition photo while showing the high-definition photo in the log-in state.

The service providing server supports the member joining to be enabled through an e-mail and an SNS account.

When the user terminal device detects an input for a decoration tab 324, the screen of the user terminal device is switched to the decoration screen, and the decoration screen is related to FIG. 3C.

That is, the user terminal device which is in a edition waiting state inputs the QR code, is paid with a basic digital image, and moves to the decoration page when detecting the input for the decoration tab 324.

FIG. 3C illustrates a page for decoration and modification in the service procedure of the issuing the custom decorated digital images as the NFT according to an exemplary embodiment of the present invention.

Referring to FIG. 3C, in a decoration case 330, a decoration sticker type indication 331, a decoration target selection list indication 332, a decoration sticker 333 disposed on a decoration target digital image, and a decoration setting change tab 334 are illustrated.

Further, in a modification case 340, a modification type indication 341, a modification target area 342, and a decoration setting change tab 343 are illustrated.

It is possible to individually change a size of the decoration sticker 333 selected in the decoration sticker type indication 331.

Decoration and modification may be cancelled, reset, and completed according to options in the decoration setting change tab 334 and the decoration setting change tab 343.

When the decoration and the modification are completed, a custom decorated digital image which is currently displayed is stored.

That is, the user terminal device stores the custom decorated digital image after decoration completion.

FIG. 3D illustrates an NFT creation page in the service procedure of the issuing the custom decorated digital images as the NFT according to an exemplary embodiment of the present invention.

Referring to FIG. 3D, a my-own NFT creation screen 350 is illustrated, and the user terminal device provides a custom decorated digital image 352 and an NFT creation tab 351 in the my-own NFT creation screen 350.

The user terminal device enters a process for creating the custom decorated digital image 352 as the NFT when detecting an input for the NFT creation tab 351.

The user terminal device provides a message representing that NFT issuance for the custom decorated digital image 352 is possible only once.

When the user terminal device receives an agreement for the terms and conditions related to the NFT issuance through an additional pop-up window, the user terminal device conducts the NFT issuance process.

There is a possibility that the blockchain will take a predetermined time upon congestion in the blockchain server.

The user terminal device and the service providing server support the NFT issued in the NFT page in MY COLLECTION after the issuance of the NFT is completed.

FIG. 3E illustrates an NFT confirmation page in the service procedure of the issuing the custom decorated digital images as the NFT according to an exemplary embodiment of the present invention.

Referring to FIG. 3E, an NFT confirmation page 360 provides an NFT-edited custom decorated digital image 362 and related information 361.

The related information 361 is displayed in a latest order, a thumbnail and an NFT name are displayed, the NFT name is sequentially numbered for each collection, and when the thumbnail and an enlargement button is pressed, the screen is supported to move to an individual detailed screen.

The individual detailed screen displays list buttons including a large image, an NFT name, an owner nickname display, an NFT-edited date display, and a go-to-previous screen.

Further, the user terminal device and the service providing server may also consider supporting NFT name setting and change to be enabled if the user wants.

In other words, the user terminal device may display pre-issued NFTs according to an issuance order, display the thumbnail and names of the issued NFTs, move a detailed screen of an NFT of which name is displayed when detecting an input for the thumbnail, and provide the NFT confirmation page that displays the custom decorated digital images, names, NFT owner nicknames, and NFT issuance dates on the detailed screen.

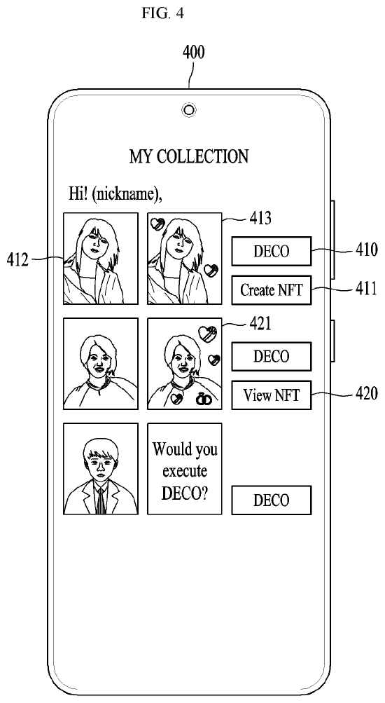

FIG. 4 is a diagram for describing a screen of managing custom decorated digital images and an issued NFT according to an exemplary embodiment of the present invention.

FIG. 4 illustrates a screen of managing custom decorated digital images and an issued NFT according to an exemplary embodiment of the present invention.

Referring to FIG. 4, a screen 400 of managing the NFT may be referred to as MY COLLECTION.

The screen 400 of managing the NFT displays and provides a digital image 412, a custom decorated digital image 413, a decoration tab 410 for decorating the digital image 412 to the custom decorated digital image 413, and an NFT creation tab 411 for issuing the custom decorated digital image 413 as the NFT.

Further, the screen 400 of managing the NFT provides an NFT view tab 420 for viewing a digital image 421 issued as the NFT.

Further, the screen 400 of managing the NFT may also jointly provide a tab for inducing decoration for a digital image which is not decorated.

The screen 400 of managing the NFT supports the original digital image, the decorated digital image, and the NFT-edited digital image to be confirmed once in one page.

A list first displays a recently stored image in sequence, and displays all decoration-or NFT-edition completed digital images.

When the input for the tab is detected for each digital image, the screen may move to the decoration page or the NFT page.

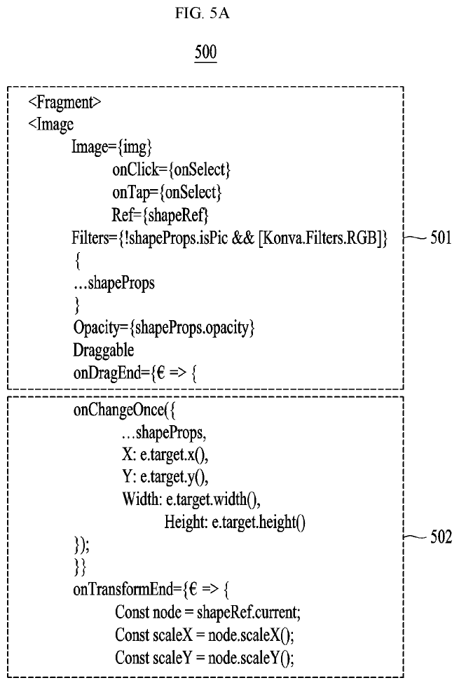

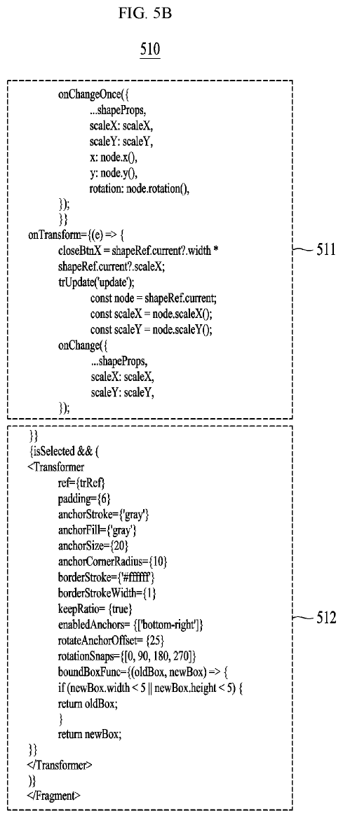

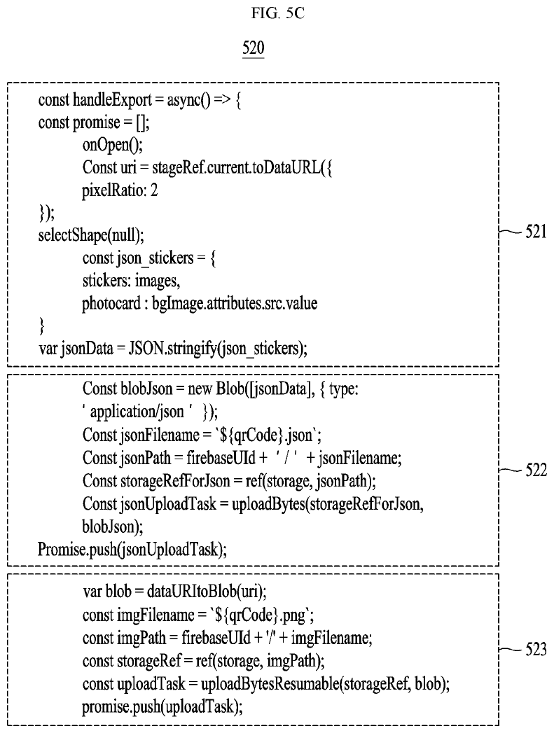

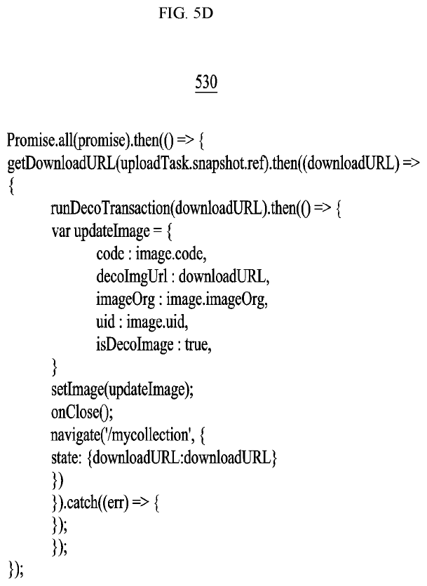

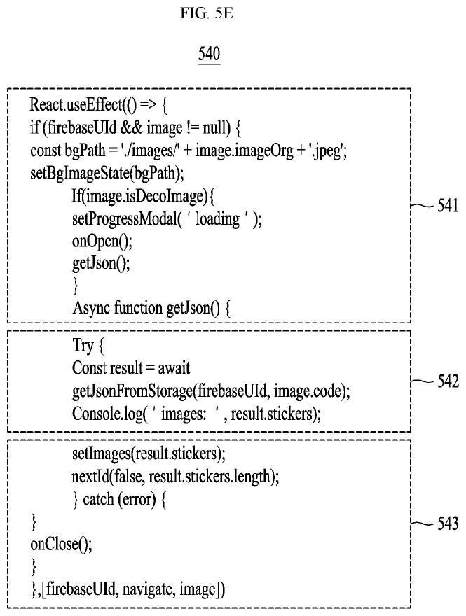

FIGS. 5A to 5E are diagrams for describing a decoration code for generating custom decorated digital images according to an exemplary embodiment of the present invention.

FIGS. 5A to 5E illustrate a decoration code for generating custom decorated digital images according to an exemplary embodiment of the present invention.

The decoration code is generated for the purpose of decoration object edition implementation, and movement, enlargement, reduction, and rotation of a selected object are possible, and additionally, application of a color filter, color change, and transparency control are possible for each object element.

Further, the decoration code supports efficient decoration state implementation through calling the coordinate and the attribute value, and list thumbnail image implementation through a state screenshot to which the coordinate and the attribute value are reflected.

Further, a history is stored for each edition, and undo is possible for each step of an edition process, and an edition state may be reconfigured based on data stored in the service providing server.

As a result, the service providing server is capable of rapidly and efficiently providing an additional edition in the user terminal device, and may support an edited final result to be converted into an image file and uploaded to a server, and linked to an NFT issuance step in an uploaded digital image state.

Referring to FIG. 5A, a decoration code 500 represents a beginning part of the decoration object edition.

In a code part 501, Image indicates each one decoration object, and an array per object includes a decoration attribute and a coordinate value of the object.

Click and Tap may represent object selection for an action.

In a code part 502, onChangeOnce is related to supporting history update for an attribute change of a decoration object.

Referring to FIG. 5B, a decoration code 510 supports a history update for the attribute change of the decoration object based on onChangeOnce in a code part 511.

The decoration code 510 represents finishing of an edition interval source while representing a storage source for each edition and process of decoration objects selected in the code part 511 and a code part 512.

Referring to FIG. 5C, a decoration code 520 is related to a code that uploads image information which is being edited by starting of an interval source uploaded in a JSON format to the server in the JSON format.

Attribute data upload of each decoration object using the JSON format as a format advantageous for a Web based service environment is made to easily correspond to an inter-system object exchange by using a programming language and the JSON format independent of a platform.

Further, the JSON format may be utilized for JSON Paser mounted on a universal web browser.

A code part 521 applies a resolution double when storing the image to implement an efficient environment to be established when editing by the user.

A code part 522 is related to a part containing the attribute information of the decoration object, and supports new Blob to be generated by generation of JSON: blob.

A code part 523 may be related to dataURltoBlob(uri), and generation of image:blob may be related to a part that loads an image in a state to which a decoration attribute value is applied.

Referring to FIG. 5D, a decoration code 530 may be a code part which allows both JSON and image to be stored in the JSON file storage unit.

The decoration code 530 may be a last part of an interval source which uploads the image in the JSON related attribute format.

Referring to FIG. 5E, a decoration code 540 as code parts for efficiently providing the additional edition supports the additional edition to be facilitated by reconfiguring the edition state based on the data stored in the service providing server.

A code part 541 is a part for confirming whether an attribute of a decoration image which is being edited previously or has been edited is stored.

A code part 542 is a part for calling the stored attribute value when the attribute of the decoration image is stored.

A code part 543 may be a part for reconfiguring the screen based on the information of the corresponding part and expressing the screen to the user.

That is, the decoration code may support to call a coordinate and an attribute value of at least one decoration sticker selected on the digital image based on the functional implementation, modify the called coordinate and attribute value according to the decoration edition, and recall the modified coordinate and attribute value to generate the custom decorated digital image and display the generated digital image on the screen.

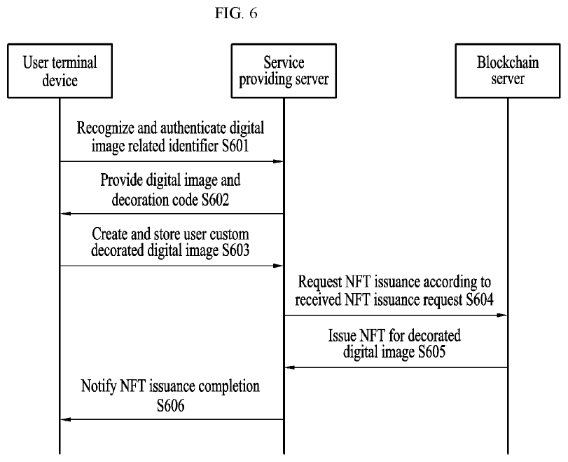

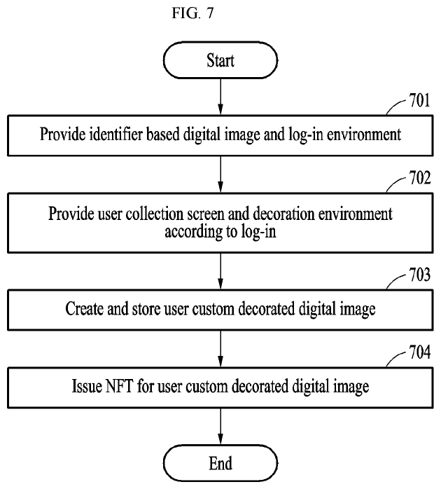

FIGS. 6 and 7 are diagrams for describing a method for editing custom decorated digital images as an NFT which issue custom decorated digital images as the NFT according to an exemplary embodiment of the present invention.

FIG. 6 illustrates the method for editing custom decorated digital images as an NFT which issue custom decorated digital images as the NFT according to an exemplary embodiment of the present invention by operations between system components. Hereinafter, for convenience of description, the method for editing custom decorated digital images and issuing them as the NFT will be described as an NFT issuance method.

In step S601, in the NFT issuance method, the user terminal device performs a step of recognizing and authenticating a digital image related identifier.

That is, in the NFT issuance method, an identifier recognizing and authenticating process for being paid with the digital image through QR code recognition and authentication by the user terminal device is performed.

In step S602, in the NFT issuance method, a step of providing the digital image and the decoration code to the user terminal device by the service providing server is performed.

That is, in the NFT issuance method, a process of downloading a decoration target or an original digital image from the user terminal device and providing a decoration code to perform decoration for the downloaded digital image by the service providing server is performed.

In step S603, in the NFT issuance method, the user terminal device performs generation and storage of the custom decorated digital image.

That is, in the NFT issuance method, a process is performed in which the user terminal device enters a decoration page related to a digital image to be decorated, and performs the decoration edition on a digital image provided based on the decoration code provided in the decoration page to generate and store the custom decorated digital image.

In step S604, in the NFT issuance method, the service providing server performs an NFT issuance request according to the NFT issuance request received from the user terminal device.

That is, in the NFT issuance method, a process is performed in which the service providing server receives the NFT issuance request for the custom decorated digital image from the user terminal device and transfers the NFT issuance request to the blockchain server.

In step S605, in the NFT issuance method, the blockchain server conducts NFT issuance for the decorated digital image.

That is, in the NFT issuance method, a process is performed in which the blockchain server performs issues the NFT for the custom decorated digital image to the service providing server.

In step S606, in the NFT issuance method, the service providing server transfers an NFT issuance completion notification to the user terminal device.

That is, the NFT issuance method provides the issued NFT to the decentralization wallet of the user terminal device.

FIG. 7 illustrates a system operation procedure in the NFT issuance method of issuing the custom decorated digital images as the NFT according to an exemplary embodiment of the present invention.

Referring to FIG. 7, in step 701, the NFT issuance method provides an identifier based digital image and a log-in environment.

That is, the NFT issuance method recognizes a QR code as an identifier and confirms whether a normal access is made according to whether the QR code is a QR code in which up to member joining is completed, and guides to a log-in page and provides the log-in environment.

In this case, a setting language of the user terminal device which is an access device is determined through a language check function to provide a service with the same language.

In step 702, the NFT issuance method provides a user collection screen and a decoration environment according to log-in.

That is, in the NFT issuance method, when the log-in is made, a user collection screen is displayed, which may confirm the original digital image and the decorated digital image by moving to an album possessed by the user, and when an input for a decoration tab is detected in the user collection screen, a decoration environment using a decoration sticker for the digital image is provided. Here, the provided decoration environment is related to the page described in FIG. 3C.

For example, it is possible to generate a plurality of digital images per original digital image, and it is possible to apply a rectangular or circular option, and the same image quality or image quality change according to an importance is possible in all processes.

In step S703, in the NFT issuance method, the custom decorated digital image is generated and stored.

That is, in the NFT issuance method, a custom decorated digital image is generated and stored according to the decoration edition performed in step S702.

In step S704, in the NFT issuance method, an NFT for the custom decorated digital image is issued.

That is, in the NFT issuance method, an NFT minting request for the custom decorated digital image is transferred to the blockchain server to issue the NFT.

Here, in the NFT issuance method, a process of uploading a digital image which is an NFT issuance target to an image distribution server, encoding an uploaded image address, inserting the encoded image address into a smart contract, generating the NFT in a blockchain through on-chain, and dropping the generated NFT to a decentralization wallet is conducted as one process.

In other words, in the NFT issuance method, the service providing server pays a basic digital image which is an edition target to the user terminal through the identifier, the user terminal device locates the decoration sticker in the basic digital image through a decoration sticker addition function, generates and stores the custom decorated digital image through location selection, size adjustment, rotation, and color adjustment, settles image decoration, and then requests NFT issuance to keep the issued NFT in the decentralization wallet of the user terminal device.

Therefore, the present invention can provide a system and a method for editing custom decorated digital images which issue custom decorated digital images as the NFT, which perform both a process of generating and storing custom decorated digital images and a process of issuing the custom decorated digital images as the NFT through a decoration edition of adding a decoration sticker onto the digital images according to one service flow to enhance convenience of a user.

The devices described above may be implemented by hardware components, software components, and/or combinations of the hardware components and the software components. For example, the devices and components described in the exemplary embodiments may be implemented by using one or more universal computers or special-purpose computers like any other devices a processor controller, an arithmetic logic unit (ALU), a digital signal processor, a microcomputer, a digital signal processor, a field programmable array (FPA), a programmable logic unit (PUL), a microprocessor, or any other device capable of executing and responding to an instruction. A processing device may perform an operating system (OS) and one or more software applications executed on the operating system. Further, the processing device may access, store, operate, processing, or generate data in response to execution of software. For convenience of understanding, there is a case where it is described that one processing device is used, but those skilled in the art may know that the processing device may include a plurality of processing elements and/or a plurality of types of processing elements. For example, the processing device may include a plurality of processors or one or more processors or one controller. Further, another processing configuration such as a parallel processor is also available.

The software may include a computer program, code, instructions, or a combination of one or more thereof, and configure the processing unit to operate as desired, or instruct a processing device independently or collectively. Software and/or data may be interpreted by the processing device or may be permanently or temporarily embodied in any type of machine, component, physical device, virtual equipment, computer storage medium or device, or a transmitted signal wave in order to provide instructions or data to the processing device. The software may be distributed on a computer system connected through the network and stored or executed by a distributed method. The software and the data may be stored in one or more computer readable recording media.

As described above, although the exemplary embodiments have been described by the limited drawings, those skilled in the art can perform various technical modifications and variations from the description. For example, the described techniques are performed in a different order from the described method, and/or components such as a system, structure, device, circuit, etc., described are collected or combined in a form different from the described method, or even if the components are replaced or substituted by other components or an equivalent, an appropriate result can be achieved.

Therefore, other implementations, other exemplary embodiments and claims and equivalents fall within the scope of the following claims.

What is claimed is:

1. An NFT issuance system for issuing custom decorated digital images as a non fungible token (NFT), comprising: a user terminal device; a service providing server; and a blockchain server,
wherein the user terminal device recognizes and authenticates a digital image related identifier,
the service providing server provides a digital image and a decoration code for decoration edition to the user terminal device based on the authenticated identifier,
the user terminal device enters a decoration page related to the provided digital image, and performs the decoration edition on a digital image provided based on the provided decoration code in the decoration page to generate and store the custom decorated digital image,
the service providing server receives an NFT issuance request for the generated and stored custom decorated digital image from the user terminal device and transfers the received NFT issuance request to the blockchain server, and
the blockchain server issues an NFT for the generated and stored custom decorated digital image to the service providing server.

2. The NFT issuance system of claim 1, wherein the user terminal device recognizes and authenticates the identifier of any one of a QR code, a barcode, and an RFID tag, enters a log-in page of the service providing server, is paid with a digital image corresponding to an identifier recognized and authenticated in the entering log-in page, and performs the decoration edition on the paid digital image and combines a plurality of decoration stickers to generate and store the custom decorated digital image, and transfers an NFT issuance request for the custom decorated digital image generated and stored through the service providing server to the blockchain server to be issued with the NFT for the custom decorated digital image generated and stored through the service providing server from the blockchain server.

3. The NFT issuance system of claim 1, wherein the user terminal device selects at least one of a plurality of decoration stickers provided by the service providing server based on the provided decoration code to perform at least one decoration edition of location designation, color filter application, color change, transparency change, and size fluctuation related to movement, enlargement, reduction, and rotation of at least one decoration sticker selected on the digital image.

4. The NFT issuance system of claim 3, wherein the decoration code is configured to call a coordinate and an attribute value of at least one selected decoration sticker on the digital image, modify the called coordinate and attribute value according to the decoration edition, and recall the modified coordinate and attribute value to generate the custom decorated digital image.

5. The NFT issuance system of claim 1, wherein the service providing server uploads the generated and stored custom decorated digital image to a distribution storage, and receives individual addresses from the distribution storage to generate metadata according to a request for generating the metadata, and transfers the NFT issuance request for the generated and stored custom decorated digital image with the generated metadata to the blockchain server.

6. The NFT issuance system of claim 1, wherein the user terminal device displays the issued NFTs according to an issuance order, display the thumbnail and names of the issued NFTs, moves a detailed screen of an NFT of which name is displayed when detecting an input for the thumbnail, and displays the custom decorated digital images, names, NFT owner nicknames, and NFT issuance dates on the detailed screen.

7. The NFT issuance system of claim 1, wherein the service providing server provides the digital images and the decoration codes for the decoration edition to the user terminal device based on the authenticated identifier, and then controls a clarity for the provided digital image according to whether log-in is made in a log-in page of the service providing server in the user terminal device.

8. An NFT issuance method for issuing custom decorated digital images as a non fungible token (NFT), comprising:
recognizing and authenticating, by a user terminal device, a digital image related identifier;
providing, by a service providing server, a digital image and a decoration code for decoration edition to the user terminal device based on the authenticated identifier;
entering, by the user terminal device, a decoration page related to the provided digital image, and performing the decoration edition on a digital image provided based on the provided decoration code in the decoration page to generate and store the custom decorated digital image;
receiving, by the service providing server, an NFT issuance request for the generated and stored custom decorated digital image from the user terminal device and transfers the received NFT issuance request to the blockchain server; and
issuing, by the blockchain server, an NFT for the generated and stored custom decorated digital image to the service providing server.

9. The NFT issuance method of claim 8, further comprising:
recognizing and authenticating, by the user terminal device, the identifier of any one of a QR code, a barcode, and an RFID tag, entering a log-in page of the service providing server, being paid with a digital image corresponding to an identifier recognized and authenticated in the entering log-in page; and
performing, by the user terminal device, the decoration edition on the paid digital image and combining a plurality of decoration stickers to generate and store the custom decorated digital image, and transferring an NFT issuance request for the custom decorated digital image generated and stored through the service providing server to the blockchain server to be issued with the NFT for the custom decorated digital image generated and stored through the service providing server from the blockchain server.

10. The NFT issuance method of claim 8, wherein the entering of, by the user terminal device, the decoration page related to the provided digital image, and performing the decoration edition on the digital image provided based on the provided decoration code in the decoration page to generate and store the custom decorated digital image includes
selecting at least one of a plurality of decoration stickers provided by the service providing server based on the provided decoration code to perform at least one decoration edition of location designation, color filter application, color change, transparency change, and size fluctuation related to movement, enlargement, reduction, and rotation of at least one decoration sticker selected on the digital image, and
the decoration code is configured to call a coordinate and an attribute value of at least one selected decoration sticker on the digital image, modify the called coordinate and attribute value according to the decoration edition, and recall the modified coordinate and attribute value to generate the custom decorated digital image.

11. The NFT issuance method of claim 8, wherein the receiving of the NFT issuance request for the generated and stored custom decorated digital image from the user terminal device and transferring the received NFT issuance request to the blockchain server includes
uploading the generated and stored custom decorated digital image to a distribution storage, and receiving individual addresses from the distribution storage to generate metadata according to a request for generating the metadata, and transferring the NFT issuance request for the generated and stored custom decorated digital image with the generated metadata to the blockchain server.

12. The NFT issuance method of claim 8, wherein the providing of the digital image and the decoration code for decoration edition to the user terminal device based on the authenticated identifier includes
providing the digital images and the decoration codes for the decoration edition to the user terminal device based on the authenticated identifier, and then controlling a clarity for the provided digital image according to whether log-in is made in a log-in page of the service providing server in the user terminal device.

13. A service providing server of an NFT issuance system for issuing custom decorated digital images as a non fungible token (NFT), comprising:
an identifier registration unit providing, after recognizing and authenticating a digital image related identifier by a user terminal device, a digital image to the user terminal device based on the authenticated identifier;
a decoration performing unit providing a decoration code for decoration edition in relation to the provided digital image, and performing the decoration edition on the provided digital image based on the provided decoration code in the decoration page to generate and store the custom decorated digital image;
an NFT issuance unit receiving an NFT issuance request for the generated and stored custom decorated digital image from the user terminal device and transferring the received NFT issuance request to a blockchain server; and
an NFT withdrawal unit requesting NFT withdrawal so as for the blockchain server to issue an NFT for the generated and stored custom decorated digital image.

14. The service providing server of claim 13, wherein the decoration performing unit supports the user terminal device to select at least one of a plurality of decoration stickers provided by the service providing server based on the provided decoration code to perform at least one decoration edition of location designation, color filter application, color change, transparency change, and size fluctuation related to movement, enlargement, reduction, and rotation of at least one decoration sticker selected on the digital image.

15. The service providing server of claim 14, wherein the decoration code is configured to call a coordinate and an attribute value of at least one selected decoration sticker on the digital image, modify the called coordinate and attribute value according to the decoration edition, and recall the modified coordinate and attribute value to generate the custom decorated digital image.
